(19) United States
(12) Patent Application Publication
(10) Pub. No.: US 2016/0155089 A1
(43) Pub. Date: Jun. 2, 2016

(54) COMPONENT SELECTION DEVICE AND COMPONENT SELECTION METHOD

(71) Applicant: FUJITSU LIMITED, Kawasaki-shi (JP)

(72) Inventors: Tomokazu NAKASHIMA, Kawasaki (JP); Masayuki ITOH, Kawasaki (JP); Kiyokazu MORIIZUMI, Kawasaki (JP)

(73) Assignee: FUJITSU LIMITED, Kawasaki-shi (JP)

(21) Appl. No.: 15/014,442

(22) Filed: Feb. 3, 2016

Related U.S. Application Data
(63) Continuation of application No. PCT/JP2014/071249, filed on Aug. 11, 2014.

(30) Foreign Application Priority Data
Aug. 13, 2013 (JP) 2013-168368

(51) Int. Cl. G06Q 10/08; G06Q 10/06

(52) U.S. Cl. CPC G06Q 10/0875; G06Q 10/06315

(57) ABSTRACT

A computer-readable recording medium stores therein a program that causes a computer to execute a process. The process includes receiving a condition for using a component; referring to a stored content of a first storage unit that stores a characteristic value of the component for each condition for using the component, thereby acquiring a characteristic value that is related to the received condition; referring to a stored content of a second storage unit that stores a price of the component, thereby acquiring the price that is related to the component; normalizing the acquired price by using the acquired characteristic value; and outputting the normalized price.

### CROSS-REFERENCE TO RELATED APPLICATIONS

This application is a continuation of International Application No. PCT/JP2014/071249, filed on Aug. 11, 2014 which claims the benefit of priority of the prior Japanese Patent Application No. 2013-168368, filed on Aug. 13, 2013, the entire contents of which are incorporated herein by reference.

### FIELD

The embodiments discussed herein are directed to a computer-readable recording medium, a component selection device, and a component selection method.

### BACKGROUND

There are conventional technologies for selecting a component, such as a ceramic capacitor. In the following explanation, a ceramic capacitor is sometimes referred to as a “CC” for abbreviation. An explanation is given of an example of the conventional technology by using a CC as an example. According to the conventional technology, for instance, when a circuit is designed, a CC, for which the rate of the price with respect to the rated capacity, published by the manufacturer that manufactures the CC, is lowest, is selected from candidate CCs, and the information about the selected CC is presented to a user, such as a designer who designs the circuit. Thus, the user sees the presented CC to determine the CC that is to be used in the circuit.

Patent Literature 1: Japanese Laid-open Patent Publication No. 2003-16293

Patent Literature 2: Japanese Laid-open Patent Publication No. 2011-175341

Patent Literature 3: Japanese Laid-open Patent Publication No. 2008-243010

However, the conventional technologies have a problem in that it is difficult to select a component in accordance with the characteristics under the condition for actually using the component. An explanation is given by using a CC as an example. For instance, the effective capacity of the CC is changed in accordance with the level of the applied voltage. Therefore, the following situation sometimes occurs even in a case where, with regard to a CC A and a CC B, the rate of the price of the CC A with respect to the rated capacity is lower than the rate of the price of the CC B with respect to the rated capacity. Specifically, a situation sometimes occurs, in which, when the CC A and the CC B are used under the condition where a certain level of voltage is applied, the rate of the price of the CC B with respect to the effective capacity is lower than the rate of the price of the CC A with respect to the effective capacity. However, according to the conventional technology, even if such a situation occurs, the CC A, of which the rate of the price with respect to the rated capacity is lower, is selected from the CC A and the CC B without any consideration on the characteristics under the condition for actually using the CC A and the CC B. Then, in the conventional technology, the information about the selected CC A is presented. Thus, the conventional technology has a problem in that it is difficult to select a component in accordance with the characteristics under the condition for actually using the component. Furthermore, such a problem may also occur not only in a case where a CC is selected, but also in a case where a different capacitor, an electronic component other than a capacitor, or the like, is selected.

### SUMMARY

According to an aspect of an embodiment, a computer-readable recording medium stores therein a program that causes a computer to execute a process. The process includes receiving a condition for using a component; referring to a stored content of a first storage unit that stores a characteristic value of the component for each condition for using the component, thereby acquiring a characteristic value that is related to the received condition; referring to a stored content of a second storage unit that stores a price of the component, thereby acquiring the price that is related to the component; normalizing the acquired price by using the acquired characteristic value; and outputting the normalized price.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram that illustrates an example of the functional configuration of a component selection device according to a first embodiment;

FIG. 2 is a diagram that illustrates an example of the data structure of component information;

FIG. 3 is a graph that illustrates an example of a variable parameter;

FIG. 4 is a diagram that illustrates an example of the data structure of price information;

FIG. 5 is a diagram that illustrates an example of the data structure of a determination table;

FIG. 6 is a diagram that illustrates an example of the data structure of selection information;

FIG. 7 is a diagram that illustrates an example of a search screen;

FIG. 8 is a diagram that illustrates an example of the operation that is performed by a selecting unit according to the first embodiment;

FIG. 9 is a flowchart that illustrates the steps of a component selection operation according to the first embodiment;

FIG. 10 is a diagram that illustrates an example of the functional configuration of a component selection device according to a second embodiment;

FIG. 11 is a diagram that illustrates an example of the registered contents of a determination table according to the second embodiment;

FIG. 12 is a flowchart that illustrates the steps of a determination-table registration operation according to the second embodiment;

FIG. 13 is a flowchart that illustrates the steps of the component selection operation according to the second embodiment;

FIG. 14 is a diagram that illustrates an example of the configuration of a system according to a third embodiment; and

FIG. 15 is a diagram that illustrates a computer that executes a component selection program.

### DESCRIPTION OF EMBODIMENTS

Preferred embodiments of the present invention will be explained with reference to accompanying drawings. Furthermore, each embodiment is not a limitation of the disclosed technology.

### [a] First Embodiment

### Example of the Functional Configuration of the Component Selection Device

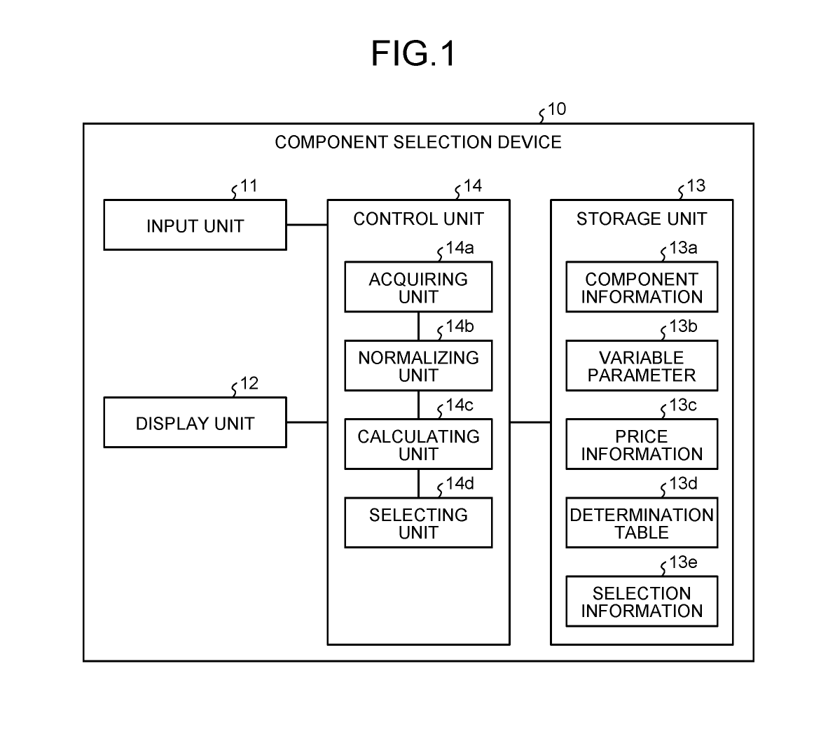

An explanation is given of a component selection device according to the first embodiment. FIG. 1 is a diagram that illustrates an example of the functional configuration of the component selection device according to the first embodiment.

As illustrated in FIG. 1, a component selection device 10 includes an input unit 11, a display unit 12, a storage unit 13, and a control unit 14.

The input unit 11 inputs various types of information to the control unit 14. For example, if a command for performing a component selection operation, described later, is received from a user, such as a designer who designs a circuit, the input unit 11 inputs the received command to the control unit 14. Exemplary devices of the input unit 11 include devices that receive a user's operation, such as mouse or keyboard.

The display unit 12 outputs various types of information. For example, the display unit 12 displays the search screen, which is described later, under the control of an acquiring unit 14a that is described later. Furthermore, under the control of a selecting unit 14d, which is described later, the display unit 12 displays the contents of the top N records in rankings out of all the records in selection information 13e that is described below. Exemplary devices of the display unit 12 include a liquid crystal display.

The storage unit 13 stores various types of information. For example, the storage unit 13 stores component information 13a, a variable parameter 13b, price information 13c, a determination table 13d, and the selection information 13e.

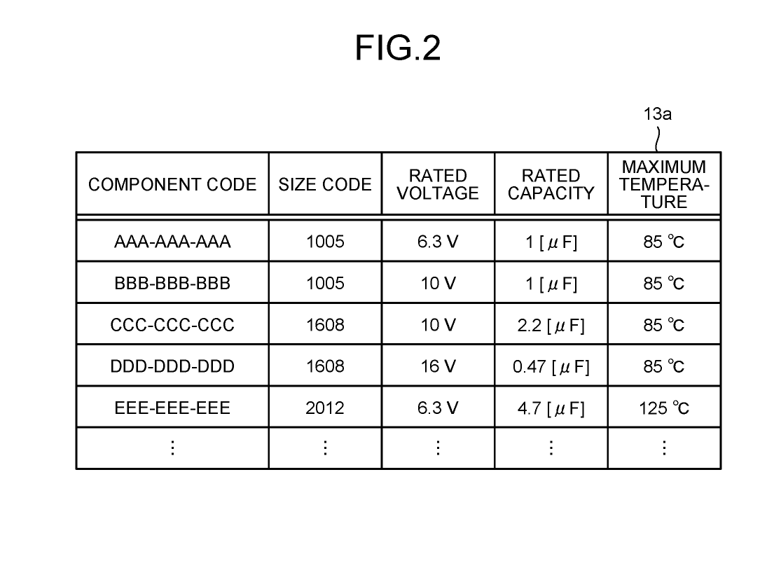

The component information 13a registers information on various components. In the following descriptions, an explanation is given of a case where a component is a CC; however, any component may be used as the component. FIG. 2 is a diagram that illustrates an example of the data structure of the component information. As illustrated in the example of FIG. 2, the component information 13a contains various items of “component code”, “size code”, “rated voltage”, “rated capacity”, and “maximum temperature”. The component information 13a registers information on a component in each record.

In the item “component code”, the component code for identifying the component is previously registered. In the item “size code” is previously registered the size code that indicates the size of the component that is identified by using the component code that is registered in the item “component code”. In the item “rated voltage” is previously registered the rated voltage that is published by the manufacturer, which manufactures the component, for the component that is identified by using the component code that is registered in the item “component code”. In the item “rated capacity” is previously registered the rated capacity that is published by the manufacturer, which manufactures the component, for the component that is identified by using the component code that is registered in the item “component code”. In the item “maximum temperature” is previously registered the temperature of the upper limit, at which the component may be used, identified by using the component code that is registered in the item “component code”.

For example, the first record in the component information 13a, illustrated in the example of FIG. 2, indicates that the size of the component, identified by using the component code “AAA-AAA-AAA”, is “1.0 mm×0.5 mm”, the rated voltage is “6.3 V”, and the rated capacity is “1 [μF]”. Furthermore, the first record in the component information 13a, illustrated in the example of FIG. 2, indicates that the temperature of the upper limit, at which the component identified by using the component code “AAA-AAA-AAA” may be used, is “85° C.”. Furthermore, the same holds for the other records.

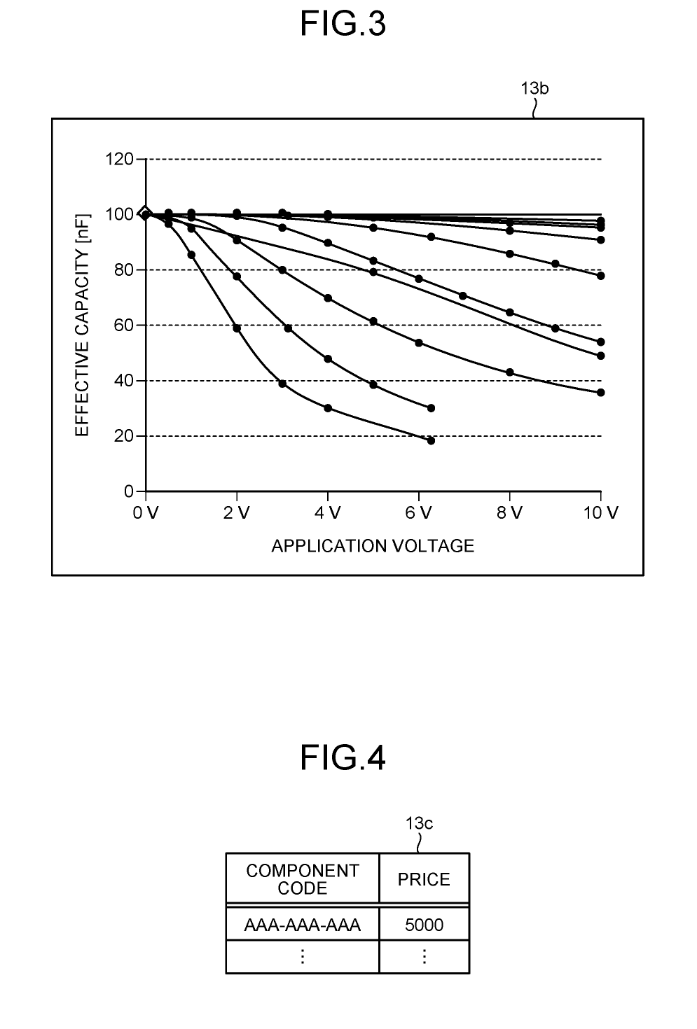

With reference back to FIG. 1, the variable parameter 13b registers, for each type of CC, the graph that indicates the relation between the level of the voltage that is applied to the CC and the effective capacity of the CC. FIG. 3 is a graph that illustrates an example of the variable parameter. The variable parameter 13b, illustrated in the example of FIG. 3, registers the graph that is related to each of the types of CCs. Each graph in the variable parameter 13b, illustrated in the example of FIG. 3, is obtained by connecting the effective capacities of the CC in line in the cases where the applied voltage is 1 V, 2 V, 3 V, 4 V, 5 V, and 6 V. Therefore, each graph indicates data on the effective capacities of the CC in the cases where the applied voltage is 1 V, 2 V, 3 V, 4 V, 5 V, and 6 V, and each graph does not store data on the effective capacity that corresponds to the case where the applied voltage is 1.2 V, or the like. In addition, some of the graphs in the variable parameter 13b, illustrated in the example of FIG. 3, are obtained by connecting the effective capacities of the CC in line in the cases where the applied voltage is 7 V, 8 V, 9 V, and 10 V. Here, the component code, which is registered in the above-described component information 13a, is related to any one of the graphs that are registered in the variable parameter 13b. That is, with regard to all the components that are identified by using the component code that is registered in the above-described component information 13a, the relation between the level of the applied voltage and the effective capacity is indicated by any one of the graphs that are registered in the variable parameter 13b.

With reference back to FIG. 1, the price information 13c registers the price of a component on a per-component basis. FIG. 4 is a diagram that illustrates an example of the data structure of the price information. As illustrated in the example of FIG. 4, the price information 13c contains the items “component code” and “price”. In the item “component code”, the component code is previously registered. In the item “price” is previously registered the price of the component that is identified by using the component code that is registered in “component code”. The first record in the price information 13c, illustrated in the example of FIG. 4, indicates that the price of the component, identified by using the component code “AAA-AAA-AAA”, is “5000 yen”.

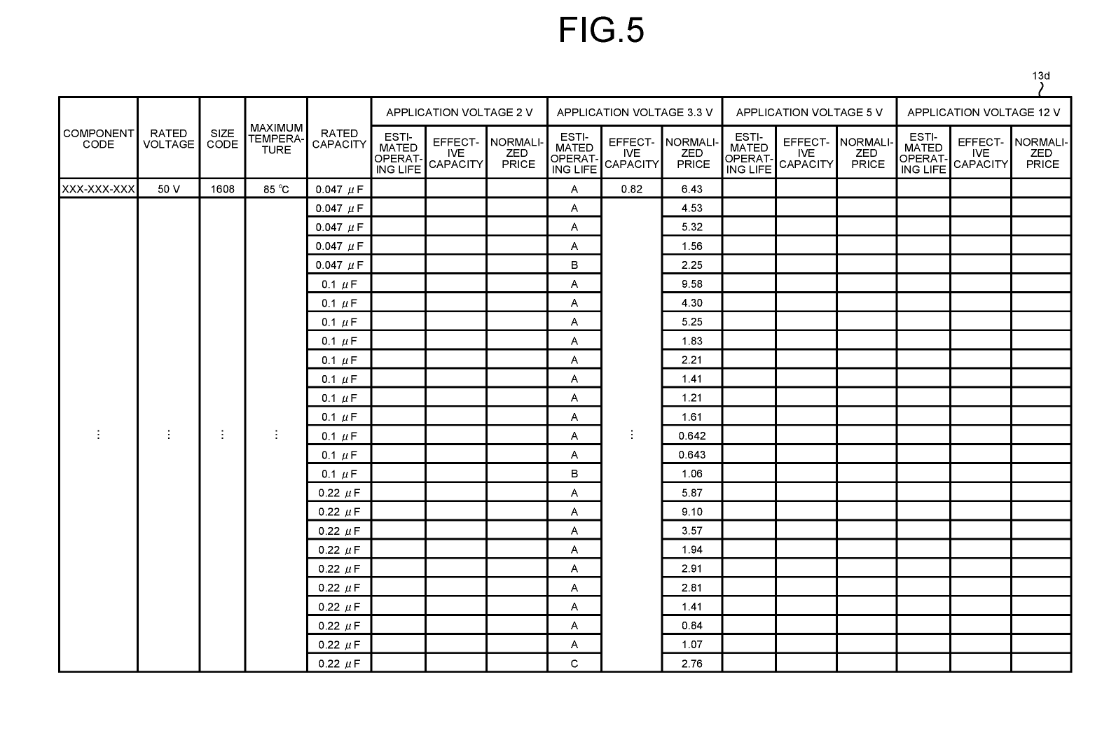

With reference back to FIG. 1, in the determination table 13d, a calculating unit 14c, which is described below, registers, for each component, the estimated operating life, which is described later, and the normalized price, which is described later, in a case where the use voltage, which is input to the search screen that is described later, is applied to the component as well as the information on the component. FIG. 5 is a diagram that illustrates an example of the data structure of the determination table. As illustrated in the example of FIG. 5, the determination table 13d contains the items “component code”, “rated voltage”, “size code”, “rated capacity”, “maximum temperature”, “estimated operating life”, “effective capacity”, and “normalized price”. Here, the determination table 13d, illustrated in the example of FIG. 5, contains the items “estimated operating life”, “effective capacity”, and “normalized price” with regard to each of the four voltages 2 V, 3.3 V, 5 V, and 12 V, which are used as the power-supply voltage of the circuit.

The component code is registered in the item “component code” by the calculating unit 14c that is described later. The rated voltage of the component, identified by using the component code that is registered in the item “component code”, is registered in the item “rated voltage” by the calculating unit 14c that is described later. The size code of the component, identified by using the component code that is registered in the item “component code”, is registered in the item “size code” by the calculating unit 14c that is described later. The rated capacity of the component, identified by using the component code that is registered in the item “component code”, is registered in the item “rated capacity” by the calculating unit 14c that is described later. The temperature of the upper limit, at which the component, identified by using the component code that is registered in the item “component code”, may be used, is registered in the item “maximum temperature” by the calculating unit 14c that is described later.

In the item “estimated operating life” that is related to the voltage that is closest to the use voltage, which is input to the search screen that is described later, the estimated operating life, which is described below, in a case where the use voltage is applied to the component is registered by the calculating unit 14c, which is described later. The example of FIG. 5 illustrates a case where the rank that corresponds to the length of the estimated operating life is registered in the item “estimated operating life” in a case where the use voltage “3.3 V” is input to the search screen, which is described later, and “3.3 V” is applied to the component. For example, “A”, registered in the item “estimated operating life” illustrated in the example of FIG. 5, indicates that the estimated operating life is equal to or more than 10 years. Furthermore, “B” indicates that the estimated operating life is equal to or more than 5 years and is less than 10 years. Furthermore, “C” indicates that the estimated operating life is less than 5 years. Moreover, the value of the estimated operating life may be registered in the item “estimated operating life” by the calculating unit 14c that is described later.

In the item “effective capacity” that is related to the voltage that is closest to the use voltage, which is input to the search screen that is described later, the effective capacity in a case where the use voltage is applied to the component is registered by the calculating unit 14c that is described later. The example of FIG. 5 illustrates a case where the effective capacity in a case where the use voltage “3.3 V” is input to the search screen, which is described later, and “3.3 V” is applied to the component is registered in the item “effective capacity” by the calculating unit 14c that is described later. Furthermore, the example of FIG. 5 illustrates a case where nothing is registered in the items “estimated operating life”, “effective capacity”, and “normalized price” that are related to the voltages “2 V”, “5 V”, and “12 V”.

In the item “normalized price” that is related to the voltage that is closest to the use voltage, which is input to the search screen that is described later, the normalized price, which is described later, in a case where the use voltage is applied to the component is registered by the calculating unit 14c that is described later. The example of FIG. 5 illustrates a case where the normalized price, which is described below, in a case where the use voltage “3.3 V” is input to the search screen, which is described later, and “3.3 V” is applied to the component is registered in the item “normalized price” by the calculating unit 14c that is described later.

The first record in the determination table 13d, illustrated in the example of FIG. 5, indicates that the rated voltage of the component identified by using the component code “XXX-XXX-XXX” is “50 V” and the size is “1.6 mm×0.8 mm”. Furthermore, the first record in the determination table 13d, illustrated in the example of FIG. 5, indicates that the temperature of the upper limit, at which the component identified by using the component code “XXX-XXX-XXX” may be used, is “85° C.” and the rated capacity of the component is “0.047 ρF”. Furthermore, the first record in the determination table 13d, illustrated in the example of FIG. 5, indicates that the estimated operating life, which is described later, of the component identified by using the component code “XXX-XXX-XXX” is equal to or more than 10 years. Furthermore, the first record in the determination table 13d, illustrated in the example of FIG. 5, indicates that the effective capacity of the component identified by using the component code “XXX-XXX-XXX” is “0.82 [μF]”. Furthermore, the first record in the determination table 13d, illustrated in the example of FIG. 5, indicates that the normalized price, which is described later, of the component identified by using the component code “XXX-XXX-XXX” is “6.43”. Furthermore, the same holds for the other records.

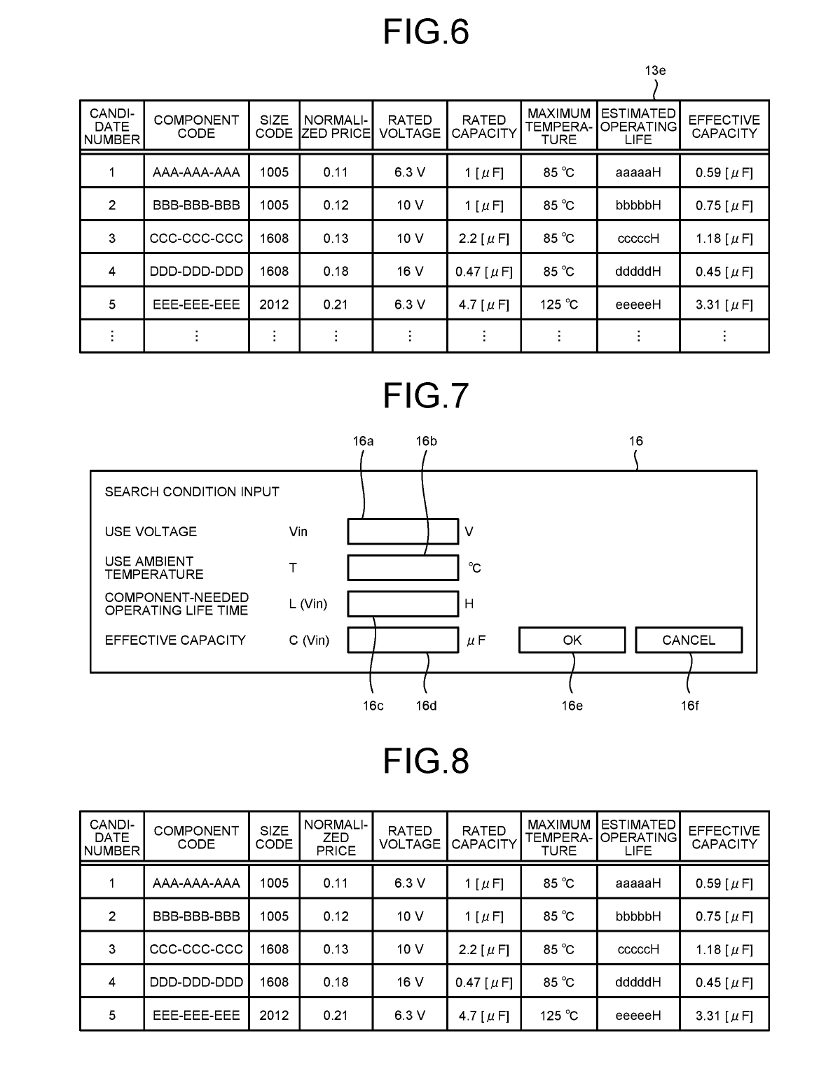

With reference back to FIG. 1, the selection information 13e has the component information, the after-mentioned normalized price, the after-mentioned estimated operating life, and the effective capacity of the component, registered by the selecting unit 14d that is described later. FIG. 6 is a diagram that illustrates an example of the data structure of the selection information 13e. As illustrated in the example of FIG. 6, the selection information 13e contains the items “candidate number”, “component code”, “size code”, “normalized price”, “rated voltage”, “rated capacity”, “maximum temperature”, “estimated operating life”, and “effective capacity”.

In the item “candidate number”, the rank of the component in a case where the normalized price is sorted in ascending order is registered by the selecting unit 14d that is described later. In the item “component code”, the component code is registered by the selecting unit 14d that is described later. In the item “size code”, the size code of the component, identified by using the component code that is registered in the item “component code”, is registered by the selecting unit 14d that is described later. In the item “normalized price”, the normalized price, which is described later, is registered by the selecting unit 14d that is described later. In the item “rated voltage”, the rated voltage of the component, identified by using the component code that is registered in the item “component code”, is registered by the selecting unit 14d that is described later. In the item “rated capacity”, the rated capacity of the component, identified by using the component code that is registered in the item “component code”, is registered by the selecting unit 14d that is described later. In the item “maximum temperature”, the temperature of the upper limit, at which the component identified by using the component code that is registered in the item “component code” may be used, is registered by the selecting unit 14d that is described later. In the item “estimated operating life”, the estimated operating life, which is described later, is registered by the selecting unit 14d that is described later. In the item “effective capacity”, the effective capacity of the component, identified by using the component code that is registered in the item “component code”, is registered by the selecting unit 14d that is described later.

The first record in the selection information 13e, illustrated in the example of FIG. 6, indicates that the rank of the component, identified by using the component code “AAA-AAA-AAA”, is “No. 1”, the size is “1.0 mm×0.5 mm”, and the normalized price is “0.11”. Furthermore, the first record in the selection information 13e, illustrated in the example of FIG. 6, indicates that the rated voltage of the component, identified by using the component code “AAA-AAA-AAA”, is “6.3 V” and the rated capacity is “1 [μF]”. Furthermore, the first record in the selection information 13e, illustrated in the example of FIG. 6, indicates that the temperature of the upper limit, at which the component identified by using the component code “AAA-AAA-AAA” may be used, is “85° C.” and the estimated operating life of the component is “aaaaa hours”. Furthermore, the first record in the selection information 13e, illustrated in the example of FIG. 6, indicates that the effective capacity of the component, identified by using the component code “AAA-AAA-AAA”, is “0.59 [μF]”. The same holds for the other records.

With reference back to FIG. 1, the storage unit 13 is, for example, a semiconductor memory device, such as a flash memory, or a storage device, such as a hard disk or an optical disk. Here, the storage unit 13 is not limited to the above-described type of storage device, and it may be a random access memory (RAM) or a read only memory (ROM).

The control unit 14 includes an internal memory for storing programs that define various procedures and control data and, by using them, performs various operations. As illustrated in FIG. 1, the control unit 14 includes the acquiring unit 14a, a normalizing unit 14b, the calculating unit 14c, and the selecting unit 14d.

The acquiring unit 14a acquires various types of information. For example, if a command for performing a component selection operation is input from the input unit 11, the acquiring unit 14a controls the display unit 12 so as to display the search screen. FIG. 7 is a diagram that illustrates an example of the search screen. A search screen 16, illustrated in the example of FIG. 7, includes a text box 16a for inputting the voltage (the use voltage) that is applied to the CC, the component, under the actual use condition. Furthermore, the search screen 16 includes a text box 16b for inputting the ambient temperature (the use ambient temperature), at which the CC is used, under the actual use condition. Furthermore, the search screen 16 includes a text box 16c for inputting the needed operating life time (component-needed operating life time) that is needed by the user when the CC is used. Furthermore, the search screen 16 includes a text box 16d for inputting the minimum effective capacity of the CC in a case where the CC is used. Furthermore, the search screen 16 includes a button 16e for confirming the contents that are input to the text boxes 16a to 16d. If the input unit 11 is operated so that the button 16e is pressed, the contents that are input to the text boxes 16a to 16d are confirmed, and the search screen 16 is closed. Furthermore, the search screen 16 includes a button 16f for closing the search screen 16. If the input unit 11 is operated so that the button 16e is pressed, the search screen 16 is closed.

For example, if a user, such as a designer who designs a circuit, operates the input unit 11 to input the command for performing the component selection operation to the control unit 14, the acquiring unit 14a controls the display unit 12 so as to display the search screen 16. If the user operates the input unit 11 to input the use voltage, the use ambient temperature, the component-needed operating life time, and the effective capacity to the text boxes 16a to 16d and presses the button 16e, the acquiring unit 14a performs the following operation. That is, the acquiring unit 14a acquires the use voltage, the use ambient temperature, the component-needed operating life time, and the effective capacity, which are input to the text boxes 16a to 16d.

By performing the above-described operation, the acquiring unit 14a receives various conditions (the use voltage, the use ambient temperature, the component-needed operating life time, and the effective capacity), under which the component is used.

Then, from the component information 13a, the acquiring unit 14a acquires the record that registers, in the item “rated capacity”, any capacity in the range from (the effective capacity−α), which is subtraction of a predetermined value α from the received effective capacity, to (the effective capacity+α), which is addition of the predetermined value α to the effective capacity. Furthermore, if the received effective capacity is “0.1 [μF]”, the acquiring unit 14a may acquire a record in, for example, the range from “0.047 [μF]” to “0.22 [μF]” in accordance with the series, such as E3 series. For the acquiring unit 14a, the targets for various operations, which are described below, are various types of information that are registered in the record with the effective capacity that is close to the received effective capacity instead of all the records in the component information 13a, whereby the operations may be easily performed, compared to the case where the targets for the operations are all the records.

Next, the acquiring unit 14a selects an unselected record from the acquired records one by one. Furthermore, each time an unselected record is selected one by one, the acquiring unit 14a performs the following operation. That is, the acquiring unit 14a performs the following operation on all the acquired records.

For example, the acquiring unit 14a acquires the rated voltage from the item “rated voltage” in the selected record. Then, the acquiring unit 14a determines whether the acquired rated voltage is equal to or more than the received use voltage. In a case where the acquired rated voltage is less than the received use voltage, if the use voltage is applied to the component that is identified by using the component code that is registered in the item “component code” in the selected record, there is a possibility of a failure; therefore, the acquiring unit 14a performs the following operation. Specifically, if there is an unselected record, the acquiring unit 14a selects one new unselected record.

Conversely, if the acquired rated voltage is equal to or more than the received use voltage, the acquiring unit 14a acquires the component code from the item “component code” in the selected record. For example, if “AAA-AAA-AAA” is registered in the item “component code” of the selected record, the acquiring unit 14a acquires “AAA-AAA-AAA”.

Then, the acquiring unit 14a refers to the variable parameter 13b to determine the graph that is related to the acquired component code among the graphs that are registered in the variable parameter 13b. For example, if “AAA-AAA-AAA” is acquired, the acquiring unit 14a determines the graph that is related to “AAA-AAA-AAA”.

Next, the acquiring unit 14a acquires the effective capacity that corresponds to the received use voltage from the determined graph. Here, in each case where the received use voltage is 1 V, 2 V, 3 V, 4 V, 5 V, or 6 V, or the like, the acquiring unit 14a acquires the effective capacity of the CC, corresponding to the received use voltage, from the determined graph. Furthermore, if the received use voltage is the voltage that is not stored in the variable parameter 13b, e.g., 1.2 V, the acquiring unit 14a performs the following operation. Specifically, the acquiring unit 14a uses the effective capacity that is related to the voltage around the use voltage to calculate the effective capacity that is related to the use voltage according to a known interpolation technique. For example, if the use voltage is 1.2 V, the effective capacity that is related to the received use voltage is calculated according to a known interpolation technique by using the effective capacity in a case where the applied voltage is 1 V and the effective capacity in a case where the applied voltage is 2 V. By performing the above-described operation, the acquiring unit 14a acquires the effective capacity. Therefore, according to the present embodiment, the effective capacity may be calculated by using the variable parameter 13b that registers the small number of relations between the effective capacity and the application voltage.

Then, the acquiring unit 14a determines whether the acquired effective capacity is equal to or more than the received effective capacity. If the acquired effective capacity is less than the received effective capacity, the CC, which is the component identified by using the component code that is registered in the item “component code” of the selected record, does not satisfy the effective capacity under the actual use condition. In this case, if there is an unselected record, the acquiring unit 14a selects one new unselected record.

Conversely, if the acquired effective capacity is equal to or more than the received effective capacity, the effective capacity of the CC, which is the component identified by using the component code that is registered in the item “component code” of the selected record, under the actual use condition is equal to or more than the received effective capacity. In this case, the acquiring unit 14a acquires the price that is related to the acquired component code from the price information 13c. For example, if “AAA-AAA-AAA” is acquired, the acquiring unit 14a acquires the price “5000 yen” that is related to “AAA-AAA-AAA” from the price information 13c, which is illustrated above in the example of FIG. 4.

The acquiring unit 14a performs the above-described operation on all the acquired records. As described above, the acquiring unit 14a acquires the characteristic value, such as the effective capacity, which is related to the received condition, such as the use voltage. Furthermore, the acquiring unit 14a acquires the price that is related to the component that is identified by using the component code that is registered in the selected record.

The normalizing unit 14b normalizes the acquired price by using the acquired characteristic value. An explanation is given of an aspect of the normalizing unit 14b. For example, the normalizing unit 14b performs the following operation on all the records that are selected by the acquiring unit 14a on a per-record basis. Specifically, if the effective capacity and the price are acquired by the acquiring unit 14a, the normalizing unit 14b divides the price, which is acquired by the acquiring unit 14a, by the effective capacity that is acquired by the acquiring unit 14a, thereby calculating the normalized price.

Here, the normalized price indicates the price per unit of capacity, i.e., effective capacity, of the CC under the actual use condition. Therefore, if the predetermined number, equal to or more than one, of components are selected from multiple components, the predetermined number of components is sequentially selected, starting from the component with the lowest normalized price, whereby it is possible to select a component under the actual use condition.

The calculating unit 14c calculates the estimated operating life. An explanation is given of an aspect of the calculating unit 14c. For example, the calculating unit 14c performs the following operation on all the records that are selected by the acquiring unit 14a on a per-record basis. Specifically, if the normalized price is calculated by the normalizing unit 14b, the calculating unit 14c calculates an estimated operating life L of the component, which is identified by using the component code that is registered in the record selected by the acquiring unit 14a, in accordance with the following Equation (1).

L=Lo×2^{((To-T)/θ)}×(RV×Vo/V)ⁿ (1)

Here, in Equation (1), Lo is the guarantee time that is published by the manufacturer that manufactures the CC. Furthermore, To is the maximum use temperature that is published by the manufacturer that manufactures the CC. Furthermore, RV is the application voltage ratio during testing that is published by the manufacturer that manufactures the CC. Furthermore, Vo is the rated voltage that is published by the manufacturer that manufactures the CC. Furthermore, T is the use ambient temperature that is received by the acquiring unit 14a. Furthermore, V is the use voltage that is received by the acquiring unit 14a. Furthermore, θ is a temperature acceleration coefficient, for example, 10. Moreover, n is a voltage acceleration coefficient, for example, 3.

Furthermore, the calculating unit 14c registers, in the determination table 13d, various types of information registered in the record that is selected by the acquiring unit 14a, the normalized price that is calculated by the normalizing unit 14b, and the estimated operating life that is calculated by the calculating unit 14c. For example, the calculating unit 14c adds one record to the determination table 13d and registers, in the item “component code” of the added record, the component code that is registered in the item “component code” of the record that is selected by the acquiring unit 14a. Furthermore, the calculating unit 14c registers, in the item “rated voltage” of the added record, the rated voltage that is registered in the item “rated voltage” of the record that is selected by the acquiring unit 14a. Furthermore, the calculating unit 14c registers, in the item “size code” of the added record, the size code that is registered in the item “size code” of the record that is selected by the acquiring unit 14a. Furthermore, the calculating unit 14c registers, in the item “rated capacity” of the added record, the rated capacity that is registered in the item “rated capacity” of the record that is selected by the acquiring unit 14a. Furthermore, the calculating unit 14c registers, in the item “estimated operating life” that is related to the voltage that is closest to the use voltage, received by the acquiring unit 14a, in the added record, the rank that corresponds to the value of the calculated estimated operating life or the length of the estimated operating life. Furthermore, the calculating unit 14c registers, in the item “effective capacity” that is related to the voltage that is closest to the use voltage, received by the acquiring unit 14a, in the added record, the effective capacity that is calculated by the normalizing unit 14b. Furthermore, the calculating unit 14c registers, in the item “normalized price” that is related to the voltage that is closest to the use voltage, received by the acquiring unit 14a, in the added record, the normalized price that is calculated by the normalizing unit 14b.

The calculating unit 14c performs the above-described operation on all the records that are acquired by the acquiring unit 14a.

The selecting unit 14d selects a component. An explanation is given of an aspect of the selecting unit 14d. For example, if the above-described operation is performed on all the records that are acquired by the acquiring unit 14a, the selecting unit 14d selects an unselected record from all the records in the determination table 13d one by one. Furthermore, each time an unselected record is selected one by one, the selecting unit 14d performs the following operation. That is, the selecting unit 14d performs the following operation on all the records in the determination table 13d on a per-record basis.

For example, the selecting unit 14d acquires the estimated operating life from the item “estimated operating life” of the selected record. Then, the selecting unit 14d determines whether the acquired estimated operating life is equal to or more than the component-needed operating life time that is received by the acquiring unit 14a. If the estimated operating life is less than the component-needed operating life time, the estimated operating life of the component, identified by using the component code that is registered in the item “component code” of the selected record, does not satisfy the received component-needed operating life time; therefore, the selecting unit 14d performs the following operation. Specifically, if there is an unselected record among the records in the determination table 13d, the selecting unit 14d selects a new unselected record.

Conversely, if the estimated operating life is equal to or more than the component-needed operating life time, the estimated operating life of the component, identified by using the component code that is registered in the item “component code” of the selected record, is equal to or more than the received component-needed operating life time; therefore, the selecting unit 14d performs the following operation. Specifically, the selecting unit 14d acquires the registered contents of all the items in the selected record. For example, the selecting unit 14d acquires the component code from the item “component code” of the selected record, the rated voltage from the item “rated voltage”, the size code from the item “size code”, and the temperature of the upper limit, at which the component may be used, from the item “maximum temperature”. In addition to them, the selecting unit 14d acquires the rated capacity from the item “rated capacity” of the selected record, the estimated operating life from the item “estimated operating life”, the effective capacity from the item “effective capacity”, and the normalized price from the item “normalized price”.

Then, the selecting unit 14d registers the acquired registered contents in the selection information 13e. For example, the selecting unit 14d adds one record to the selection information 13e and registers the acquired component code in the item “component code” of the added record. Furthermore, the selecting unit 14d registers the acquired size code in the item “size code” of the added record. Furthermore, the selecting unit 14d registers the acquired normalized price in the item “normalized price” of the added record. Furthermore, the selecting unit 14d registers the acquired rated voltage in the item “rated voltage” of the added record. Furthermore, the selecting unit 14d registers the acquired rated capacity in the item “rated capacity” of the added record. Furthermore, the selecting unit 14d registers the acquired temperature of the upper limit, at which the component may be used, in the item “maximum temperature” of the added record. Furthermore, the selecting unit 14d registers the acquired estimated operating life in the item “estimated operating life” of the added record. Moreover, the selecting unit 14d registers the acquired effective capacity in the item “effective capacity” of the added record.

The selecting unit 14d performs the above-described operation on all the records in the determination table 13d.

Then, if the above-described operation is performed on all the records in the determination table 13d, the selecting unit 14d sorts the records in the selection information 13e in ascending order of the normalized price that is registered in the item “normalized price”. Then, the selecting unit 14d registers the rank in the item “candidate number” of each record that is in ascending order of the normalized price. Next, the selecting unit 14d controls the display unit 12 so as to display the registered contents of the top N (N is a natural number equal to or more than 1) records with regard to the rank that is registered in “candidate number”. FIG. 8 is a diagram that illustrates an example of the operation that is performed by the selecting unit according to the first embodiment. For example, if the storage unit 13 stores the selection information 13e that is illustrated above in FIG. 6 and N=5, the selecting unit 14d controls the display unit 12 so as to display the screen that is illustrated in the example of FIG. 8. As described above, the selecting unit 14d selects the top N components in ascending order of the normalized price, which is the price per unit of capacity of the CC under the actual use condition, and it outputs the information about the selected component. Therefore, with the selecting unit 14d, it is possible to select a component under the actual use condition. Furthermore, after operating the input unit 11 to input the command for performing the component selection operation, the user sees the output information about the top N components so as to determine a component to be used in the circuit.

The control unit 14 is a circuit, such as an application specific integrated circuit (ASIC), a field programmable gate array (FPGA), a central processing unit (CPU), or a micro processing unit (MPU).

Flow of Operation

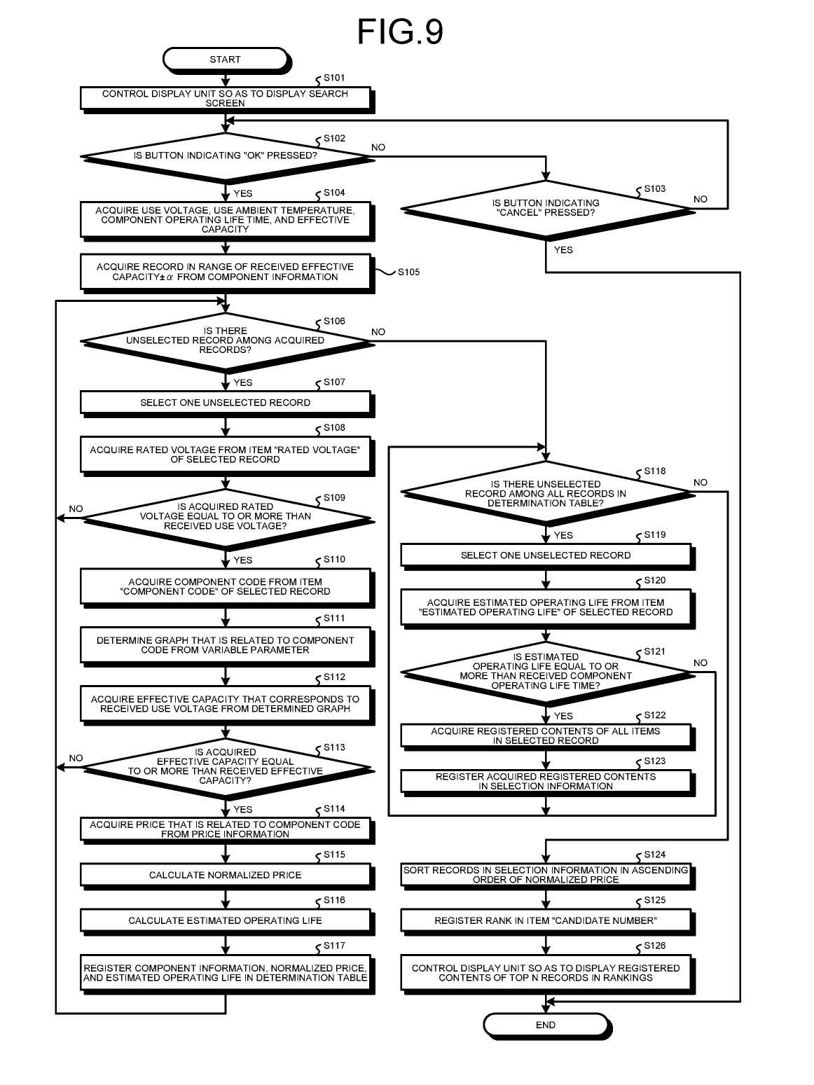

Next, an explanation is given of the flow of an operation of the component selection device 10 according to the present embodiment. FIG. 9 is a flowchart that illustrates the steps of the component selection operation according to the first embodiment. For example, the component selection operation according to the first embodiment is performed by the control unit 14, if the command for performing the component selection operation is input from the input unit 11 to the control unit 14.

As illustrated in FIG. 9, the acquiring unit 14a controls the display unit 12 so as to display the search screen 16 (S101). Then, the acquiring unit 14a determines whether the button 16e, indicating “OK”, on the search screen 16 is pressed (S102). If the button 16e is not pressed (S102; No), the acquiring unit 14a determines whether the button 16f, indicating “cancel”, on the search screen 16 is pressed (S103). If the button 16f is not pressed (S103; No), the acquiring unit 14a returns to S102 and performs the operation at S102 again. Furthermore, if the button 16f is pressed (S103; Yes), the acquiring unit 14a terminates the operation.

Conversely, if the button 16e is pressed (S102; Yes), the acquiring unit 14a acquires the use voltage, the use ambient temperature, the component-needed operating life time, and the effective capacity, which are input to the search screen 16 (S104).

Then, from the component information 13a, the acquiring unit 14a acquires the record that registers, in the item “rated capacity”, any capacity in the range from (the effective capacity−α), which is subtraction of the predetermined value α from the received effective capacity, to (the effective capacity+α), which is addition of the predetermined value α to the effective capacity. Furthermore, if the received effective capacity is “0.1 [μF]”, the acquiring unit 14a may acquire a record in, for example, the range from “0.047 [μF]” to “0.22 [μF]” in accordance with the series, such as E3 series (S105).

Next, the acquiring unit 14a determines whether there is an unselected record among the acquired records (S106). If there is an unselected record (S106; Yes), the acquiring unit 14a selects one unselected record (S107).

Then, the acquiring unit 14a acquires the rated voltage from the item “rated voltage” of the selected record (S108). Next, the acquiring unit 14a determines whether the acquired rated voltage is equal to or more than the received use voltage (S109). If the acquired rated voltage is less than the received use voltage (S109; No), the acquiring unit 14a returns to S106 and performs the operation at S106 again.

Conversely, if the acquired rated voltage is equal to or more than the received use voltage (S109; Yes), the acquiring unit 14a acquires the component code from the item “component code” of the selected record (S110). Next, the acquiring unit 14a refers to the variable parameter 13b to determine the graph that is related to the acquired component code among the graphs that are registered in the variable parameter 13b (S111).

Then, the acquiring unit 14a acquires the effective capacity that corresponds to the received use voltage from the determined graph. Here, in each case where the received use voltage is 1 V, 2 V, 3 V, 4 V, 5 V, or 6 V, or the like, the acquiring unit 14a acquires the effective capacity of the CC, corresponding to the received use voltage, from the determined graph. Furthermore, if the received use voltage is 1.2 V, or the like, the acquiring unit 14a performs the following operation. Specifically, the acquiring unit 14a uses the effective capacity in a case where the applied voltage is 1 V and the effective capacity in a case where the applied voltage is 2V to calculate the effective capacity that corresponds to the received use voltage according to known interpolation (S112).

Then, the acquiring unit 14a determines whether the acquired effective capacity is equal to or more than the received effective capacity (S113). If the acquired effective capacity is not equal to or more than the received effective capacity (S113; No), the acquiring unit 14a performs the following operation. Specifically, as the component, identified by using the component code that is registered in the item “component code” of the selected record, does not satisfy the effective capacity under the actual use condition, the acquiring unit 14a returns to S106 and performs the operation at S106.

Conversely, if the acquired effective capacity is equal to or more than the received effective capacity (S113; Yes), the effective capacity of the CC, identified by using the component code that is registered in the item “component code” of the selected record, under the actual use condition is equal to or more than the received effective capacity. In this case, the acquiring unit 14a acquires the price that is related to the acquired component code from the price information 13c (S114).

The normalizing unit 14b divides the price that is acquired by the acquiring unit 14a by the effective capacity that is acquired by the acquiring unit 14a, thereby calculating the normalized price (S115). The calculating unit 14c calculates the estimated operating life in accordance with the above-described Equation (1) (S116). Then, the calculating unit 14c registers, in the determination table 13d, various types of information that is registered in the record that is selected by the acquiring unit 14a, the normalized price, the effective capacity, and the estimated operating life (S117). Then, S106 is returned, and the operation at S106 is performed again.

Here, if there is no unselected records (S106; No), the selecting unit 14d determines whether there is an unselected record among all the records in the determination table 13d (S118). If there is an unselected record (S118; Yes), the selecting unit 14d selects one unselected record (S119).

Then, the selecting unit 14d acquires the estimated operating life from the item “estimated operating life” of the selected record (S120). Then, the selecting unit 14d determines whether the acquired estimated operating life is equal to or more than the component-needed operating life time that is received by the acquiring unit 14a (S121). If the estimated operating life is less than the component-needed operating life time (S121; No), the selecting unit 14d returns to S118 again to perform the operation at S118.

Conversely, if the estimated operating life is equal to or more than the component-needed operating life time (S121; Yes), the selecting unit 14d acquires the registered contents of all the items in the selected record (S122).

Then, the selecting unit 14d registers the acquired registered contents in the selection information 13e (S123) and returns to S118 again to perform the operation at S118.

Conversely, if there is no unselected record (S118; No), the selecting unit 14d sorts the records in the selection information 13e in ascending order of the normalized price that is registered in the item “normalized price” (S124). Then, the selecting unit 14d registers the rank in the item “candidate number” of each record that is in ascending order of the normalized price (S125). Next, the selecting unit 14d controls the display unit 12 so as to display the registered contents of the top N (N is a natural number equal to or more than 1) records with regard to the rank that is registered in “candidate number” (S126) and terminates the operation.

As described above, the component selection device 10 according to the first embodiment receives various conditions (the use voltage, the use ambient temperature, the component-needed operating life time, and the effective capacity), under which the component is used. The component selection device 10 refers to the variable parameter 13b, determines the graph that is related to the acquired component code among the graphs that are registered in the variable parameter 13b, and acquires the effective capacity of the CC, corresponding to the received use voltage, from the determined graph. The component selection device 10 acquires the price that is related to the acquired component code from the price information 13c. The component selection device 10 divides the acquired price by the acquired effective capacity, thereby calculating the normalized price. The component selection device 10 outputs the registered contents of the top N (N is a natural number equal to or more than 1) records with regard to the rank that is registered in “candidate number”. Specifically, the component selection device 10 selects the top N components in ascending order of the normalized price, which is the price per unit of capacity of the CC under the actual use condition, and it outputs the information about the selected component. Therefore, with the component selection device 10, it is possible to select a component under the actual use condition.

Furthermore, the component selection device 10 according to the first embodiment calculates the estimated operating life of the component in accordance with the received various conditions (the use voltage and the use ambient temperature), under which the component is used. The component selection device 10 receives the component-needed operating life time of the component. Then, the component selection device 10 selects the top N components in ascending order of the normalized price with regard to the components whose estimated operating life is longer than the received component-needed operating life time, and it outputs the information about the selected component. That is, with the component selection device 10, the selection target is not the component whose estimated operating life is shorter than the component-needed operating life time; therefore, it is possible to easily perform the operation to select a component.

Furthermore, if the received use voltage is the voltage that is not stored in the variable parameter 13b, e.g., 1.2 V, the component selection device 10 according to the first embodiment performs the following operation. Specifically, the component selection device 10 uses the effective capacity that is related to the voltage around the use voltage to calculate the effective capacity that is related to the use voltage according to a known interpolation technique. That is, the component selection device 10 may calculate the effective capacity by using the variable parameter 13b that registers the small number of relations between the effective capacity and the application voltage. Thus, with the component selection device 10, it is possible to calculate the effective capacity by using the variable parameter 13b with a small data size.

### [b] Second Embodiment

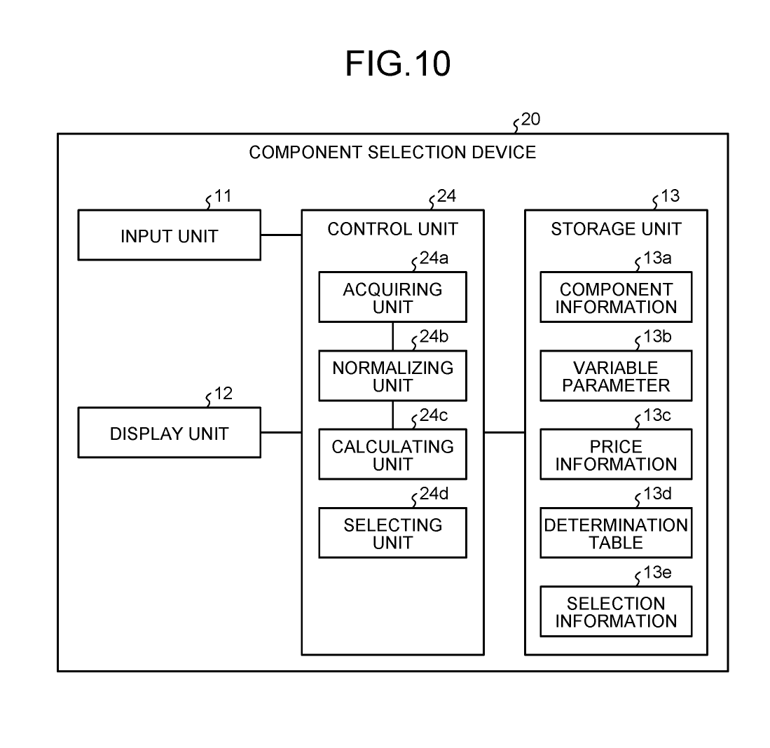

Next, an explanation is given of a component selection device according to a second embodiment. FIG. 10 is a diagram that illustrates an example of the functional configuration of the component selection device according to the second embodiment. Here, the same reference numeral is applied to the same functional configuration as that of the component selection device 10 according to the first embodiment that is illustrated above in FIG. 1, and their explanations are omitted.

Functional Configuration of the Component Selection Device

As illustrated in the example of FIG. 10, a control unit 24 of a component selection device 20 includes an acquiring unit 24a, a normalizing unit 24b, a calculating unit 24c, and a selecting unit 24d instead of each unit that is included in the control unit 14 according to the first embodiment.

The acquiring unit 24a acquires various types of information. For example, if the command for performing a determination-table registration operation is input from the input unit 11, the acquiring unit 24a acquires all the records from the component information 13a.

Next, the acquiring unit 24a selects an unselected record from the acquired records one by one. Furthermore, each time an unselected record is selected one by one, the acquiring unit 24a performs the following operation. That is, the acquiring unit 24a performs the following operation on all the acquired records on a per-record basis.

For example, the acquiring unit 24a acquires the component code from the item “component code” of the selected record. For example, if “AAA-AAA-AAA” is registered in the item “component code” of the selected record, the acquiring unit 24a acquires “AAA-AAA-AAA”.

Then, the acquiring unit 24a refers to the variable parameter 13b to determine the graph that is related to the acquired component code among the graphs that are registered in the variable parameter 13b. For example, if “AAA-AAA-AAA” is acquired, the acquiring unit 24a determines the graph that is related to “AAA-AAA-AAA”.

Then, the acquiring unit 24a selects an unselected application voltage one by one from predetermined application voltages of multiple levels. Furthermore, each time an unselected application voltage is selected one by one, the acquiring unit 24a performs the following operation. That is, the acquiring unit 24a performs the following operation on each of the predetermined application voltages of multiple levels. Here, as the predetermined application voltages of multiple levels, for example, some voltages may be used among 0.8 V, 1 V, 1.2 V, 1.8 V, 3.3 V, 5 V, 12 V, 24 V, or the like, which are used as the power-supply voltage of an electronic circuit. Furthermore, the voltage of equal to or less than 1 V may be 1 V, or the voltage of more than 1 V and equal to or less than 2 V may be 2 V. In the following description, an explanation is given of a case where, for example, the acquiring unit 24a selects an unselected application voltage one by one from the four application voltages, 2 V, 3.3 V, 5 V, and 12 V.

The acquiring unit 24a acquires the effective capacity that corresponds to the selected application voltage from the determined graph. Here, if the selected application voltage is 2 V, or the like, the acquiring unit 24a acquires the effective capacity of the CC, corresponding to the selected application voltage, from the determined graph. Conversely, if the selected application voltage is the voltage that is not stored in the variable parameter 13b, e.g., 3.3 V, the acquiring unit 24a performs the following operation. Specifically, the acquiring unit 24a uses the effective capacity that is related to the voltage around the application voltage to calculate the effective capacity that is related to the application voltage according to a known interpolation technique. For example, if the application voltage is 3.3 V, the effective capacity that is related to the selected application voltage is calculated according to a known interpolation technique by using the effective capacity in a case where the applied voltage is 3 V and the effective capacity in a case where the applied voltage is 4 V. By performing this operation, the acquiring unit 24a acquires the effective capacity. Therefore, according to the present embodiment, it is possible to calculate the effective capacity by using the variable parameter 13b whose data size is prevented from being increased.

Then, the acquiring unit 24a acquires the price that is related to the acquired component code from the price information 13c. For example, if “AAA-AAA-AAA” is acquired, the acquiring unit 24a acquires the price “5000 yen”, which is related to “AAA-AAA-AAA”, from the price information 13c that is illustrated above in the example of FIG. 4.

The acquiring unit 24a performs the above-described operation on the above-described four application voltages (2 V, 3.3 V, 5 V, and 12 V). Then, the acquiring unit 24a performs the same operation on all the records in the component information. As described above, the acquiring unit 24a acquires the characteristic value, e.g., the effective capacity, which is related to the application voltage. Furthermore, the acquiring unit 24a acquires the price that is related to the component, identified by using the component code that is registered in the selected record.

The normalizing unit 24b normalizes the acquired price by using the acquired characteristic value. An explanation is given of an aspect of the normalizing unit 24b. For example, each time the acquiring unit 24a acquires the effective capacity and the price, the normalizing unit 24b divides the price, which is acquired by the acquiring unit 24a, by the effective capacity that is acquired by the acquiring unit 24a, thereby calculating the normalized price.

The calculating unit 24c calculates the estimated operating life. An explanation is given of an aspect of the calculating unit 24c. For example, each time the normalized price is calculated by the normalizing unit 24b, the calculating unit 24c calculates an estimated operating life L1 of the component, identified by using the component code that is registered in the record selected by the acquiring unit 24a, in accordance with the following Equation (2).

L1=Lo×2^{((To-T1)/θ)}×(RV×Vo/V)ⁿ (2)

Here, in Equation (2), Lo is the guarantee time that is published by the manufacturer that manufactures the CC. Furthermore, To is the maximum use temperature that is published by the manufacturer that manufactures the CC. Furthermore, RV is the application voltage ratio during testing that is published by the manufacturer that manufactures the CC. Furthermore, Vo is the rated voltage that is published by the manufacturer that manufactures the CC. Furthermore, T1 is a predetermined reference use temperature, e.g., 65° C. Furthermore, V1 is the selected application voltage, e.g., the application voltage that is selected from, for example, 2 V, 3.3 V, 5 V, and 12 V by the acquiring unit 24a. Furthermore, θ is a temperature acceleration coefficient, for example, 10. Moreover, n is a voltage acceleration coefficient, for example, 3.

Then, the calculating unit 24c performs the following operation for each of the application voltages that are selected by the acquiring unit 24a. Specifically, the calculating unit 24c registers, in the determination table 13d, various types of information registered in the record that is selected by the acquiring unit 24a, the normalized price that is calculated by the normalizing unit 24b, the effective capacity that is acquired by the acquiring unit 24a, and the estimated operating life that is calculated by the calculating unit 24c. For example, the calculating unit 24c adds one record to the determination table 13d and registers, in the item “component code” of the added record, the component code that is registered in the item “component code” of the record that is selected by the acquiring unit 24a. Furthermore, the calculating unit 24c registers, in the item “rated voltage” of the added record, the rated voltage that is registered in the item “rated voltage” of the record that is selected by the acquiring unit 24a. Furthermore, the calculating unit 24c registers, in the item “size code” of the added record, the size code that is registered in the item “size code” of the record that is selected by the acquiring unit 24a. Furthermore, the calculating unit 24c registers, in the item “rated capacity” of the added record, the rated capacity that is registered in the item “rated capacity” of the record that is selected by the acquiring unit 24a. Furthermore, the calculating unit 24c registers, in the item “estimated operating life” that is related to the voltage that is closest to the application voltage, which is selected by the acquiring unit 24a, in the added record, the rank that corresponds to the value of the calculated estimated operating life or the length of the estimated operating life. Furthermore, the calculating unit 24c registers, in the item “effective capacity” that is related to the voltage that is closest to the application voltage, which is selected by the acquiring unit 24a, in the added record, the effective capacity that is acquired by the acquiring unit 24a. Furthermore, the calculating unit 24c registers, in the item “normalized price” that is related to the voltage that is closest to the application voltage, which is selected by the acquiring unit 24a, in the added record, the normalized price that is calculated by the normalizing unit 24b.

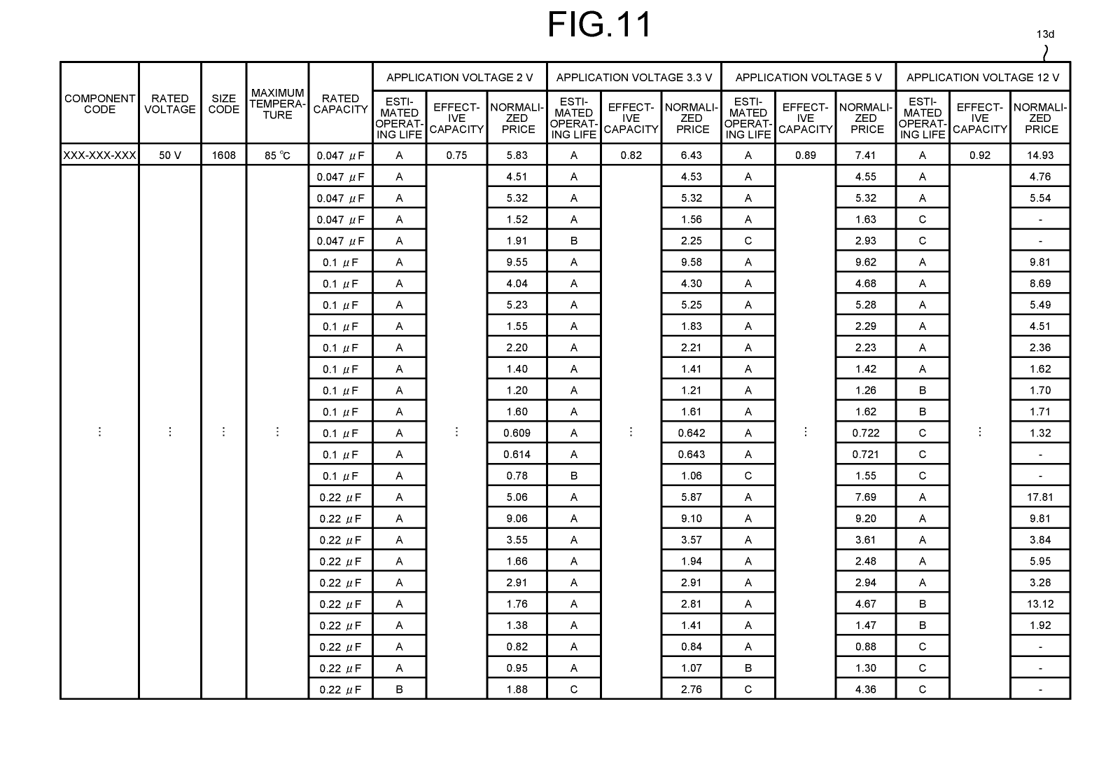

FIG. 11 is a diagram that illustrates an example of the registered contents of the determination table according to the second embodiment. By the operations that are performed by the acquiring unit 24a, the normalizing unit 24b, and the calculating unit 24c, which are described above, the estimated operating life, the effective capacity, and the normalized price, which correspond to each of the application voltages 2 V, 3.3 V, 5 V, and 12 V, are registered in the determination table 13d, as illustrated in FIG. 11. Furthermore, as illustrated in FIG. 11, various types of information, which is registered in the record that is selected by the acquiring unit 24a, is registered in the determination table 13d.

With reference back to FIG. 10, the selecting unit 24d selects a component. An explanation is given of an embodiment of the selecting unit 24d. For example, if the command for performing the component selection operation is input from the input unit 11, the selecting unit 24d controls the display unit 12 so as to display the search screen 16 that is illustrated above in the example of FIG. 7.

For example, if a user, such as a designer who designs a circuit, operates the input unit 11 to input the command for performing the component selection operation to the control unit 24, the selecting unit 24d controls the display unit 12 so as to display the search screen 16. If the user operates the input unit 11 to input the use voltage, the use ambient temperature, the component-needed operating life time, and the effective capacity to the text boxes 16a to 16d and presses the button 16e, the selecting unit 24d performs the following operation. That is, the selecting unit 24d acquires the use voltage, the use ambient temperature, the component-needed operating life time, and the effective capacity, which are input to the text boxes 16a to 16d.

By performing the above-described operation, the selecting unit 24d receives various conditions (the use voltage, the use ambient temperature, the component-needed operating life time, and the effective capacity), under which the component is used.

Then, from the determination table 13d, the selecting unit 24d acquires the record that registers, in the item “rated capacity”, any capacity in the range from (the effective capacity−α), which is subtraction of the predetermined value α from the received effective capacity, to (the effective capacity+α), which is addition of the predetermined value α to the effective capacity. Furthermore, if the received effective capacity is “0.1 [μF]”, the selecting unit 24d may acquire a record in, for example, the range from “0.047 [μF]” to “0.22 [μF]” in accordance with the series, such as E3 series. For the selecting unit 24d, the targets for various operations, which are described below, are various types of information that are registered in the record with the effective capacity that is close to the received effective capacity instead of all the records in the component information 13a, whereby the operations may be easily performed, compared to the case where the targets for the operations are all the records.

Next, the selecting unit 24d selects an unselected record from the acquired records one by one. Furthermore, each time an unselected record is selected one by one, the selecting unit 24d performs the following operation. That is, the selecting unit 24d performs the following operation on all the acquired records on a per-record basis.

For example, the selecting unit 24d acquires the rated voltage from the item “rated voltage” in the selected record. Then, the selecting unit 24d determines whether the acquired rated voltage is equal to or more than the received use voltage. In a case where the acquired rated voltage is less than the received use voltage, if the use voltage is applied to the component that is identified by using the component code that is registered in the item “component code” in the selected record, there is a possibility of a failure; therefore, the selecting unit 24d performs the following operation. Specifically, if there is an unselected record, the selecting unit 24d selects one new unselected record.

Conversely, if the acquired rated voltage is equal to or more than the received use voltage, the selecting unit 24d acquires the temperature of the upper limit, at which the component may be used, registered in the item “maximum temperature” of the selected record. Then, the selecting unit 24d determines whether the acquired temperature is equal to or more than the received use ambient temperature. If the acquired temperature is less than the received use ambient temperature, there is a possibility of a failure of the component identified by using the component code that is registered in the item “component code” of the selected record; therefore, the selecting unit 24d performs the following operation. Specifically, if there is an unselected record, the selecting unit 24d selects one new unselected record.

If the acquired temperature is equal to or more than the received use ambient temperature, the selecting unit 24d acquires the effective capacity that is registered in the item “effective capacity” that is related to the voltage that is closest to the received use voltage among the items “effective capacity” of the selected record. Then, the selecting unit 24d determines whether the acquired effective capacity is equal to or more than the received effective capacity. If the acquired effective capacity is less than the received effective capacity, the effective capacity of the CC, which is the component identified by using the component code that is registered in the item “component code” of the selected record, under the actual use condition is equal to or less than the received effective capacity. In this case, if there is an unselected record, the selecting unit 24d selects one new unselected record.

Conversely, if the acquired effective capacity is equal to or more than the received effective capacity, the effective capacity of the CC, which is the component identified by using the component code that is registered in the item “component code” of the selected record, under the actual use condition is equal to or more than the received effective capacity. In this case, the selecting unit 24d acquires the estimated operating life that is registered in the item “estimated operating life” that is related to the voltage that is closest to the received use voltage among the items “estimated operating life” of the selected record.

Then, the selecting unit 24d determines whether the received use ambient temperature matches the above reference use temperature (T1). If the received use ambient temperature does not match the above reference use temperature, the selecting unit 24d corrects the acquired estimated operating life. That is, the estimated operating life is the CC's operating life that is estimated in a case where the ambient temperature of the CC is the above reference use temperature. However, as the received use ambient temperature, i.e., the ambient temperature of the CC under the actual condition, is different from the above reference use temperature, the selecting unit 24d corrects the estimated operating life. For example, CCs have the characteristics such that, if the ambient temperature increases by 10° C., the operating life becomes (½)-fold and, if the ambient temperature decreases by 10° C., the operating life is doubled. Here, by using these characteristics, the selecting unit 24d corrects the estimated operating life. For example, if the received use ambient temperature is higher than the reference use temperature by 10° C., the selecting unit 24d sets the estimated operating life to be (½)-fold. Furthermore, if the received use ambient temperature is lower than the reference use temperature by 10° C., the selecting unit 24d doubles the estimated operating life.

Then, the selecting unit 24d determines whether the estimated operating life is equal to or more than the received component-needed operating life time. If the estimated operating life is shorter than the received component-needed operating life time, the estimated operating life of the CC, which is the component identified by using the component code that is registered in the item “component code” of the selected record, under the actual use condition is shorter than the received component-needed operating life time. In this case, if there is an unselected record, the selecting unit 24d selects one new unselected record.

Conversely, if the estimated operating life is equal to or more than the received component-needed operating life time, the received various conditions (the use voltage, the use ambient temperature, the component-needed operating life time, and the effective capacity) are satisfied; therefore, the selecting unit 24d acquires the registered contents of the selected record. For example, the selecting unit 24d acquires the component code from the item “component code” of the selected record, the rated voltage from the item “rated voltage”, the size code from the item “size code”, and the temperature of the upper limit, at which the component may be used, from the item “maximum temperature”. In addition to them, the selecting unit 24d acquires the rated capacity from the item “rated capacity” of the selected record. Furthermore, the selecting unit 24d acquires the effective capacity that is registered in the item “effective capacity” that is related to the voltage that is closest to the received use voltage among the items “effective capacity” of the selected record. Furthermore, the selecting unit 24d acquires the estimated operating life from the item “estimated operating life” that is related to the voltage that is closest to the received use voltage among the items “estimated operating life” of the selected record. Furthermore, the selecting unit 24d acquires the normalized price from the item “normalized price” that is related to the voltage that is closest to the received use voltage among the items “normalized price” of the selected record.

Then, the selecting unit 24d registers the acquired registered contents in the selection information 13e. For example, the selecting unit 24d adds one record to the selection information 13e and registers the acquired component code in the item “component code” of the added record. Furthermore, the selecting unit 24d registers the acquired size code in the item “size code” of the added record. Furthermore, the selecting unit 24d registers the acquired normalized price in the item “normalized price” of the added record. Furthermore, the selecting unit 24d registers the acquired rated voltage in the item “rated voltage” of the added record. Furthermore, the selecting unit 24d registers the acquired rated capacity in the item “rated capacity” of the added record. Furthermore, the selecting unit 24d registers the acquired temperature of the upper limit, at which the component may be used, in the item “maximum temperature” of the added record. Furthermore, the selecting unit 24d registers the acquired estimated operating life in the item “estimated operating life” of the added record. Moreover, the selecting unit 24d registers the acquired effective capacity in the item “effective capacity” of the added record.

The selecting unit 24d performs the above-described operation on all the records in the determination table 13d.

Then, if the above-described operation is performed on all the records in the determination table 13d, the selecting unit 24d sorts the records in the selection information 13e in ascending order of the normalized price that is registered in the item “normalized price”. Then, the selecting unit 24d registers the rank in the item “candidate number” of each record that is in ascending order of the normalized price. Next, the selecting unit 24d controls the display unit 12 so as to display the registered contents of the top N (N is a natural number equal to or more than 1) records with regard to the rank that is registered in “candidate number”. As described above, the selecting unit 24d selects the top N components in ascending order of the normalized price, which is the price per unit of capacity of the CC under the actual use condition, and it outputs the information about the selected component. Therefore, with the selecting unit 24d, it is possible to select a component under the actual use condition. Furthermore, after operating the input unit 11 to input the command for performing the component selection operation, the user sees the output information about the top N components so as to determine a component to be used in the circuit.

The control unit 24 is a circuit, such as an application specific integrated circuit (ASIC), a field programmable gate array (FPGA), a central processing unit (CPU), or a micro processing unit (MPU).

Flow of Operation

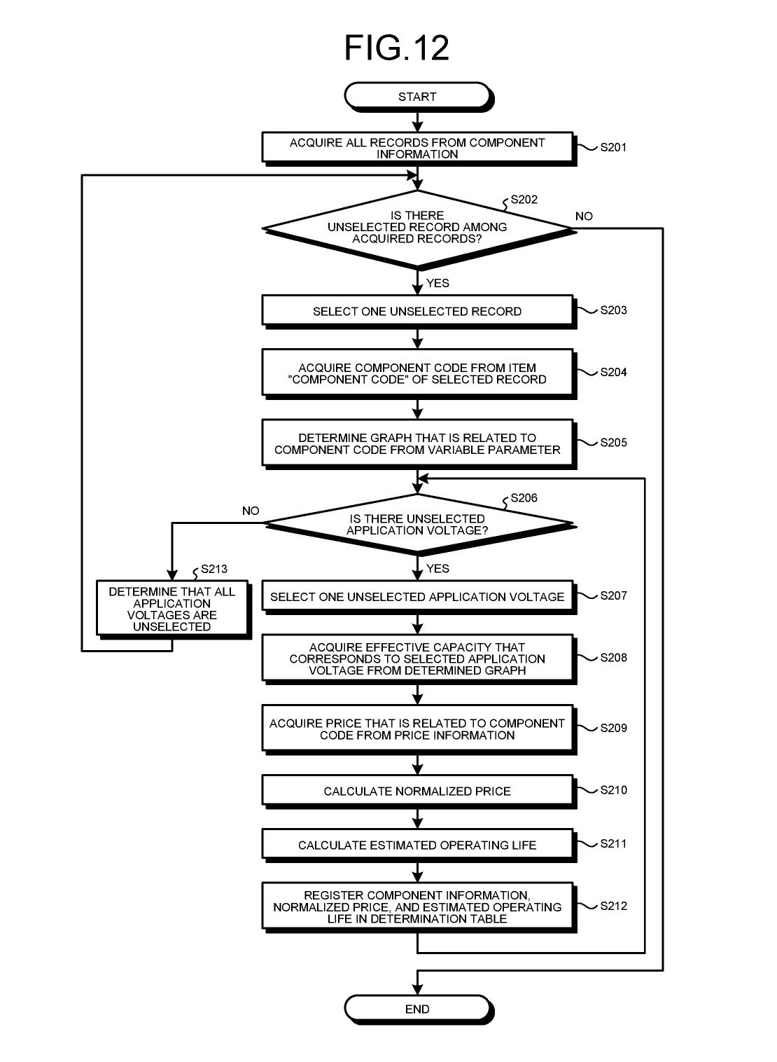

Next, an explanation is given of the flow of an operation of the component selection device 20 according to the present embodiment. FIG. 12 is a flowchart that illustrates the steps of the determination-table registration operation according to the second embodiment. For example, the determination-table registration operation according to the second embodiment is performed by the control unit 24, if the command for performing the determination-table registration operation is input from the input unit 11 to the control unit 24.

As illustrated in FIG. 12, the acquiring unit 24a acquires all the records from the component information 13a (S201). Next, the acquiring unit 24a determines whether there is an unselected record among the acquired records (S202). If there is an unselected record (S202; Yes), the acquiring unit 24a selects one unselected record (S203).

Then, the acquiring unit 24a acquires the component code from the item “component code” of the selected record (S204). Then, the acquiring unit 24a refers to the variable parameter 13b to determine the graph that is related to the acquired component code from the graphs that are registered in the variable parameter 13b (S205).

Next, the acquiring unit 24a determines whether there is an unselected application voltage among predetermined application voltages of multiple levels (S206). If there is an unselected application voltage (S206; Yes), the acquiring unit 24a selects one unselected application voltage (S207). Then, the acquiring unit 24a acquires the effective capacity that corresponds to the selected application voltage from the determined graph (S208).

Then, the acquiring unit 24a acquires the price that is related to the acquired component code from the price information 13c (S209). The normalizing unit 24b divides the price, which is acquired by the acquiring unit 24a, by the effective capacity that is acquired by the acquiring unit 24a, thereby calculating the normalized price (S210).

Then, in accordance with the above-described Equation (2), the calculating unit 24c calculates the estimated operating life L1 of the component, identified by using the component code that is registered in the record that is selected by the acquiring unit 24a (S211).

Then, the calculating unit 24c registers, in the determination table 13d, various types of information that is registered in the record, selected by the acquiring unit 24a, the normalized price, the effective capacity, and the estimated operating life (S212) and returns to S206 to perform the operation at S206. Here, if there is no unselected application voltage (S206; No), the acquiring unit 24a determines that all the application voltages of predetermined levels are unselected (S213) and returns to S202 to perform the operation at S202. Conversely, if there is no unselected record (S202; No), the calculating unit 24c terminates the operation.

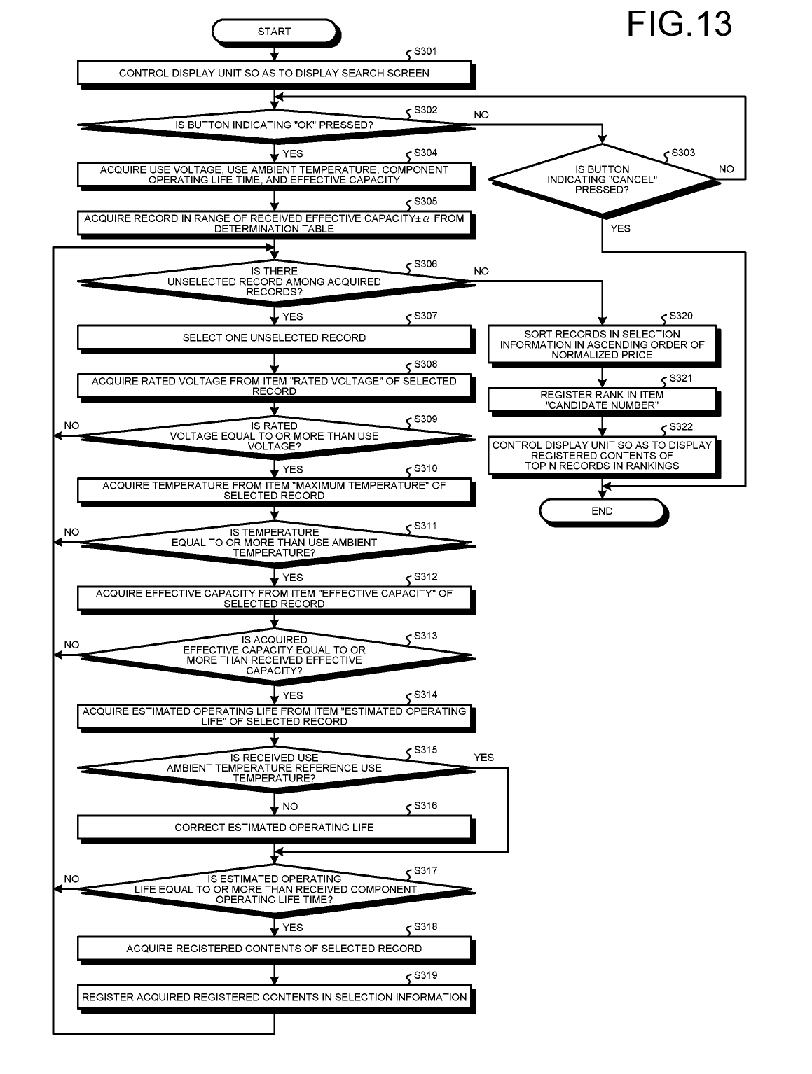

FIG. 13 is a flowchart that illustrates the steps of the component selection operation according to the second embodiment. For example, the component selection operation according to the second embodiment is performed by the control unit 24, if the command for performing the component selection operation is input from the input unit 11 to the control unit 24.

As illustrated in FIG. 13, if the command for performing the component selection operation is input from the input unit 11, the selecting unit 24d controls the display unit 12 so as to display the search screen 16 that is illustrated above in the example of FIG. 7 (S301). Then, the selecting unit 24d determines whether the button 16e, indicating “OK”, on the search screen 16 is pressed (S302). If the button 16e is not pressed (S302; No), the selecting unit 24d determines whether the button 16f, indicating “cancel”, on the search screen 16 is pressed (S303). If the button 16f is not pressed (S303; No), the selecting unit 24d returns to S302 and performs the operation at S302 again. Furthermore, if the button 16f is pressed (S303; Yes), the selecting unit 24d terminates the operation.

Conversely, if the button 16e is pressed (S302; Yes), the selecting unit 24d acquires the use voltage, the use ambient temperature, the component-needed operating life time, and the effective capacity, which are input to the search screen 16 (S304).

Then, from the determination table 13d, the selecting unit 24d acquires the record that registers, in the item “rated capacity”, any capacity in the range from (the effective capacity−α), which is subtraction of the predetermined value α from the received effective capacity, to (the effective capacity+α), which is addition of the predetermined value α to the effective capacity. Furthermore, if the received effective capacity is “0.1 [μP]”, the selecting unit 24d may acquire a record in, for example, the range from “0.047 [μF]” to “0.22 [μF]” in accordance with the series, such as E3 series (S305).

Next, the selecting unit 24d determines whether there is an unselected record among the acquired records (S306). If there is an unselected record (S306; Yes), the selecting unit 24d selects one unselected record (S307).

Then, the selecting unit 24d acquires the rated voltage from the item “rated voltage” of the selected record (S308). Next, the selecting unit 24d determines whether the acquired rated voltage is equal to or more than the received use voltage (S309). If the acquired rated voltage is less than the received use voltage (S309; No), the selecting unit 24d returns to S306 and performs the operation at S306. Conversely, if the acquired rated voltage is equal to or more than the received use voltage (S309; Yes), the selecting unit 24d acquires the temperature of the upper limit, at which the component may be used, registered in the item “maximum temperature” of the selected record (S310).

Then, the selecting unit 24d determines whether the acquired temperature is equal to or more than the received use ambient temperature (S311). If the acquired temperature is less than the received use ambient temperature (S311; No), the selecting unit 24d returns to S306 to perform the operation at S306. Conversely, if the acquired temperature is equal to or more than the received use ambient temperature (S311; Yes), the selecting unit 24d performs the following operation. Specifically, the selecting unit 24d acquires the effective capacity, which is registered in the item “effective capacity” that is related to the voltage closest to the received use voltage among the items “effective capacity” of the selected record (S312).

Then, the selecting unit 24d determines whether the acquired effective capacity is equal to or more than the received effective capacity (S313). If the acquired effective capacity is less than the received effective capacity (S313; No), the selecting unit 24d returns to S306 to perform the operation at S306.

Conversely, if the acquired effective capacity is equal to or more than the received effective capacity (S313; Yes), the selecting unit 24d performs the following operation. Specifically, the selecting unit 24d acquires the estimated operating life, which is registered in the item “estimated operating life” that is related to the voltage closest to the received use voltage among the items “estimated operating life” of the selected record (S314).

Then, the selecting unit 24d determines whether the received use ambient temperature matches the above reference use temperature (T1) (S315).

If the received use ambient temperature does not match the above reference use temperature (S315; No), the selecting unit 24d corrects the acquired estimated operating life (S316) and proceeds to S317. Furthermore, if the received use ambient temperature matches the above reference use temperature (S315; Yes), the selecting unit 24d also proceeds to S317.

At S317, the selecting unit 24d determines whether the estimated operating life is equal to or more than the component-needed operating life time. If the estimated operating life is shorter than the received component-needed operating life time (S317; No), the selecting unit 24d returns to S306 to perform the operation at S306.

Conversely, if the estimated operating life is equal to or more than the component-needed operating life time (S317; Yes), the received various conditions (the use voltage, the use ambient temperature, the component-needed operating life time, and the effective capacity) are satisfied; therefore, the selecting unit 24d acquires the registered contents of the selected record (S318).

Then, the selecting unit 24d registers the acquired registered contents in the selection information 13e (S319) and returns to S306 to perform the operation at S306.

Furthermore, if there is no unselected record (S306; No), the selecting unit 24d sorts the records in the selection information 13e in ascending order of the normalized price that is registered in the item “normalized price” (S320). Then, the selecting unit 24d registers the rank in the item “candidate number” of each record that is in ascending order of the normalized price (S321). Next, the selecting unit 24d controls the display unit 12 so as to display the registered contents of the top N (N is a natural number equal to or more than 1) records with regard to the rank that is registered in “candidate number” (S322) and terminates the operation.

As described above, the component selection device 20 according to the second embodiment outputs the registered contents of the top N (N is a natural number equal to or more than 1) records with regard to the rank that is registered in “candidate number”. Specifically, the component selection device 20 selects the top N components in ascending order of the normalized price, which is the price per unit of capacity of the CC under the actual use condition, and it outputs the information about the selected component. Therefore, with the component selection device 20, it is possible to select a component under the actual use condition.

Furthermore, the component selection device 20 according to the second embodiment calculates the estimated operating life of the component in accordance with the reference use temperature. Then, if the received use ambient temperature does not match the reference use temperature, the component selection device 20 corrects the estimated operating life and, by using the corrected estimated operating life, selects a component. Therefore, with the component selection device 20, it is possible to prevent a decrease in the accuracy of component selection.

Furthermore, if the selected application voltage is the voltage that is not stored in the variable parameter 13b, e.g., 3.3 V, the component selection device 20 according to the second embodiment performs the following operation. Specifically, the component selection device 20 uses the effective capacity that is related to the voltage around the use voltage to calculate the effective capacity that is related to the use voltage according to a known interpolation technique. That is, the component selection device 20 may calculate the effective capacity by using the variable parameter 13b that registers the small number of relations between the effective capacity and the application voltage. Thus, with the component selection device 20, the effective capacity may be calculated by using the variable parameter 13b with a small data size.

Furthermore, the component selection device 20 according to the second embodiment previously registers various contents in the determination table 13d, which simplifies the operation from when the command for performing the component selection operation is input from the input unit 11 to the control unit 24 to when a component is selected and output. Specifically, in the component selection device 20, the operation to register various contents in the determination table 13d is not synchronous with the operation to select a component and output the information about the selected component, whereby the operation is simplified.

Furthermore, according to the second embodiment, the component selection device 20 may include the acquiring unit 14a, the normalizing unit 14b, and the calculating unit 14c according to the first embodiment instead of the acquiring unit 24a, the normalizing unit 24b, and the calculating unit 24c. In this case, the acquiring unit 14a, the normalizing unit 14b, and the calculating unit 14c, which are included in the component selection device 20, may register various contents in the determination table 13d and configure the determination table 13d out of synchronization with the operation that is performed by the selecting unit 24d.

### Third Embodiment

Next, an explanation is given of a system according to a third embodiment. A component selection device in the system according to the third embodiment selects a component by using a condition that is transmitted from a circuit-design support device instead of acquiring a condition by using the above-described search screen 16 during selection of a component. Furthermore, the component selection device in the system according to the third embodiment does not store the component information 13a but selects a component by using the component information that is transmitted from the circuit-design support device. The other functions are the same as those of the component selection device 10 according to the first embodiment or the component selection device 20 according to the second embodiment, which is described above.

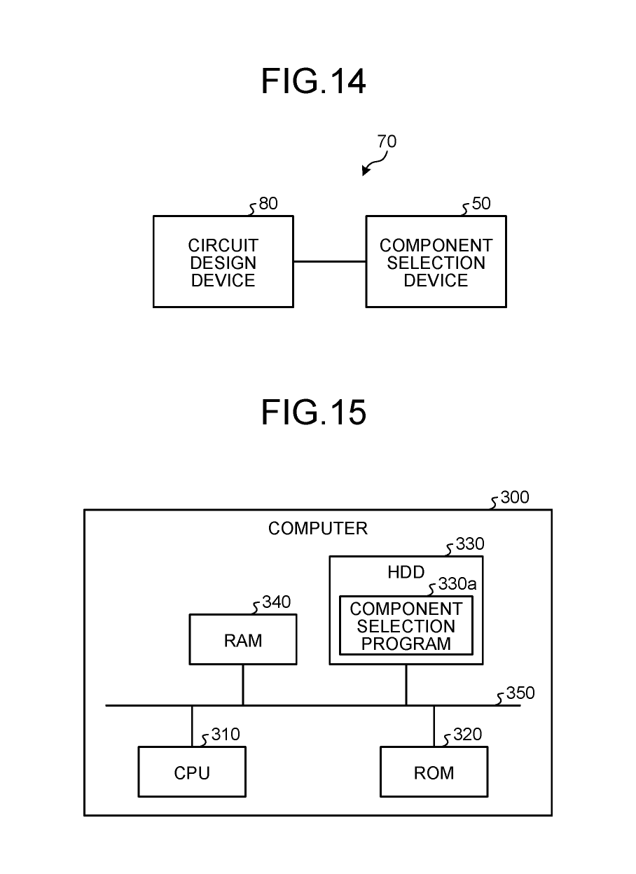

FIG. 14 is a diagram that illustrates an example of the configuration of a system according to the third embodiment. As illustrated in the example of FIG. 14, a system 70 includes a component selection device 50 and a circuit design device 80.

The circuit design device 80 is a device that supports circuit design by using a circuit-design support tool for computer aided design (CAD), or the like. The circuit design device 80 requests the component selection device 50 to output the candidate of a component, such as CC, when the circuit is designed. Furthermore, together with the request, the circuit design device 80 transmits, to the component selection device 50, the condition in the actual environment for using the component and the component information.

After receiving the condition and the component information together with the above-described request, the component selection device 50 uses the received condition and component information to select a component as is the case with the component selection device 10 or the component selection device 20 that is described above. Then, the component selection device 50 transmits the information about the selected component to the circuit design device 80. After receiving the information about the selected component, the circuit design device 80 uses the received information about the selected component to determine a component to be installed in the circuit.

As described above, a component may be easily selected by operating the circuit design device 80 and the component selection device 50 simultaneously, whereby it is possible to reduce the loads that are imposed during circuit design.

Heretofore, the embodiments of the disclosed devices have been described; however, the present invention may be implemented in various different embodiments other than the above-described embodiments. For example, the disclosed device may select a component in response to a request from a different device and transmit the information about the selected component to the device that is a requester.

Furthermore, the disclosed device may loosen the actually used condition and, in the case of a component that is not a candidate to be selected, select the component if it is operable under the loosened condition.

Furthermore, among the operations that are described in the embodiments, all or some of the operations that are automatically performed as explained may be performed manually. Furthermore, among the operations that are described in the embodiments, all or some of the operations that are manually performed as explained may be performed automatically by using a well-known method.

Furthermore, the procedure at each step of the operation that is described in each of the embodiments may be arbitrarily subdivided or combined together depending on various types of loads, usage, or the like. Moreover, steps may be omitted.

Furthermore, the order of procedures at each step of the operation that is described in each of the embodiments may be changed depending on various types of loads, usage, or the like.

The components of each device illustrated are functionally conceptual and do not always need to be physically configured as illustrated in the drawings. Specifically, specific forms of separation and combination of each device are not limited to those depicted in the drawings, and a configuration may be such that all or some of them are functionally or physically separated or combined in an arbitrary unit depending on various types of loads, usage, or the like.

Component Selection Program

Various operations of the component selection devices 10, 20, 50, which are described in the above embodiments, may be performed when prepared programs are executed by a computer system, such as a personal computer or workstation. Therefore, in the following, an explanation is given, with reference to FIG. 15, of an example of a computer that executes a component selection program that has the same functionality as that of the component selection device 10, 20, 50, which is described in each of the above embodiments. FIG. 15 is a diagram that illustrates a computer that executes the component selection program.

As illustrated in FIG. 15, a computer 300 includes a CPU 310, a ROM 320, a hard disk drive (HDD) 330, and a RAM 340. The CPU 310, the ROM 320, the HDD 330, and the RAM 340 are connected to one another via a bus 350.

The ROM 320 stores basic programs, such as an operating system (OS). Furthermore, the HDD 330 pre-stores a component selection program 330a that performs the same functionality as those of the acquiring unit 14a, the normalizing unit 14b, the calculating unit 14c, and the selecting unit 14d, which are described in the above first embodiment. Furthermore, the component selection program 330a may be a program that performs the same functionality as those of the acquiring unit 24a, the normalizing unit 24b, the calculating unit 24c, and the selecting unit 24d, which are described in the above second embodiment. Furthermore, the component selection program 330a may be separated as appropriate. Moreover, the HDD 330 is provided with various types of data and various tables that are stored in the storage unit 13.

Furthermore, the CPU 310 reads and executes the component selection program 330a from the HDD 330.

Then, the CPU 310 reads various types of data and various tables and stores them in the RAM 340. Furthermore, the CPU 310 uses various types of data and various tables, which are stored in the RAM 340, to execute the component selection program 330a. Furthermore, with regard to the data that is stored in the RAM 340, the entire data does not need to be always stored in the RAM 340. It is appropriate if the data to be used during an operation is stored in the RAM 340.

It is possible to select a component in accordance with the characteristics under the condition for actually using the component.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable non-transitory recording medium having stored therein a program that causes a computer to execute a process comprising:
receiving a condition for using a component;
referring to a stored content of a first storage unit that stores a characteristic value of the component for each condition for using the component, thereby acquiring a characteristic value that is related to the received condition;
referring to a stored content of a second storage unit that stores a price of the component, thereby acquiring the price that is related to the component;
normalizing the acquired price by using the acquired characteristic value; and
outputting the normalized price.

2. The computer-readable non-transitory recording medium according to claim 1, the process further comprising, in accordance with a received condition, estimating an operating life of the component under the condition, wherein
the receiving the condition includes receiving a condition that is related to an operating life of the component, and
the outputting the normalize price includes, when an estimated operating life satisfies the received condition that is related to the operating life of the component, outputting a normalized price with regard to the component.

3. The computer-readable non-transitory recording medium according to claim 1, wherein
the acquiring the characteristic value includes referring to a stored content of the first storage unit to acquire an effective capacity of the component under the condition,
the receiving the condition includes receiving a condition that is related to the effective capacity of the component, and
the outputting the normalized price includes, when the acquired effective capacity satisfies the received condition that is related to the effective capacity of the component, outputting a normalized price with regard to the component.

4. The computer-readable non-transitory recording medium according to claim 1, the process further comprising referring to information that is related to the component, thereby acquiring a rated voltage of the component, wherein
the receiving the condition includes receiving a condition that is related to a voltage that is applied to the component, and
the outputting the normalized price includes, when the acquired rated voltage of the component satisfies the received condition that is related to the voltage that is applied to the component, outputting a normalized price with regard to the component.

5. The computer-readable non-transitory recording medium according to claim 1, wherein the acquiring the characteristic value includes, when the characteristic value that is related to the received condition is not stored in the first storage unit, using a characteristic value, which is stored in the first storage unit, to calculate the characteristic value that is related to the received condition, thereby acquiring the characteristic value.

6. The computer-readable non-transitory recording medium according to claim 1, wherein the normalizing the acquired price by using the acquired characteristic value is performed out of synchronization with the outputting the normalized price.

7. The computer-readable non-transitory recording medium according to claim 1, wherein
the receiving the condition includes receiving the condition that is transmitted from a device that designs a circuit, and
the outputting the normalized price includes outputting the normalized price to the device.

8. A component selection device comprising:
a storage unit that stores a characteristic value of a component for each condition for using the component and that stores a price of the component; and
a processor that executes a process, the process comprising:
receiving a condition for using a component;
referring to a stored content of a first storage unit that stores a characteristic value of the component for each condition for using the component, thereby acquiring a characteristic value that is related to the received condition;
referring to a stored content of a second storage unit that stores a price of the component, thereby acquiring the price that is related to the component;
normalizing the acquired price by using the acquired characteristic value; and
outputting the normalized price.

9. A component selection method comprising:
receiving a condition for using a component;
referring to a stored content of a first storage unit that stores a characteristic value of the component for each condition for using the component, thereby acquiring a characteristic value that is related to the received condition;
referring to a stored content of a second storage unit that stores a price of the component, thereby acquiring the price that is related to the component;
normalizing the acquired price by using the acquired characteristic value; and
outputting the normalized price.
